(19) United States
(12) Patent Application Publication
(10) Pub. No.: US 2019/0159625 A1
(43) Pub. Date: May 30, 2019

(54) COLLAPSIBLE CONTAINER SYSTEMS

(71) Applicant: Bear Minimum LLC, Spokane, WA (US)

(72) Inventor: Cory Santiago, Spokane, WA (US)

(21) Appl. No.: 15/967,144

(22) PCT Filed: Aug. 11, 2017
(86) PCT No.: PCT/US17/46476

§ 371 Date: Apr. 30, 2018

Related U.S. Application Data
(60) Provisional application No. 62/375,741, filed on Aug. 16, 2016.

(51) Int. Cl. A47J 33/00; A47J 27/00; A47J 36/02

(52) U.S. Cl. CPC A47J 33/00; A47J 36/02; A47J 27/002

(57) ABSTRACT

A collapsible container includes a first member formed of a first material. The first member to fold between a planar shape, a receptacle shape, and a collapsed shape. The receptacle shape including a bottom surface having a footprint and a wall having a first portion, a second portion, a third portion, and a fourth portion, each of the first portion, the second portion, the third portion, and the forth portion fixed to the footprint. A second member formed of a second material different than the first material and attached to the bottom surface of the first member. When the first member is in the collapsed shape, the first portion, the second portion, the third portion, and the fourth portion of the wall are stacked on the bottom surface opposite the second member.

### RELATED APPLICATIONS

This application is a national stage application of an international patent application PCT/US17/46476, filed Aug. 11, 2017, which claims priority to U.S. Provisional Application 62/375,741 filed Aug. 16, 2016, which applications are hereby incorporated in their entireties by reference.

### BACKGROUND

Cookware (e.g., campground cookware, backcountry cookware, etc.) can be bulky and consume large amounts of space. This is particularly true for rigid pots, bowls, or cups where the pots, bowls, or cups have large volumes for containing liquids or solids. For example, pots, bowls, or cups can have a three-dimensional space to provide for containing liquids or solids but the pot or bowl may be rigid and unable to reduce the three-dimensional space it occupies for better portability.

Moreover, cookware can be heavy and have a large amount of mass. This is particularly true for pots, bowls, or cups formed of a material that is resistant to damage by fire and/or resistant to damage from imparted forces. For example, a pot, bowl, or cup may be formed of a material (e.g., a metal, a glass, a ceramic, etc.) to provide for heating liquids or solids and resist being damaged or compromised, however the pots, bowls, or cups may be relatively heavy making them more difficult to carry.

Moreover, cookware can be difficult to clean. For example, pots, bowls, or cups may have pockets, corners, notches, edges, etc., that may collect and retain liquids and/or solids making it more difficult for a user to vacate the liquids and/or solids from the pots, bowls, or cups, making them more difficult to clean.

Accordingly there remains a need in the art for cookware, that has a large volume for containing liquids and/or solids, reduces down from the large volume for containing liquids and/or solids to a volume smaller than the larger volume for better portability, is lightweight, and is easily cleaned.

### SUMMARY

Collapsible cookware systems (e.g., campground cookware, backcountry cookware, etc.) according to the instant disclosure are configured to cook liquids and/or solids (e.g., sustenance, nourishment, food, fuel, etc.). Generally, the collapsible cookware systems include collapsible containers for cooking liquids and/or solids that may be foldable between a planar shape, a receptacle shape, and a collapsed shape. When in the receptacle shape, the collapsible containers may retain liquid and/or solids for relatively quick cooking, when in the collapsed shape the collapsible containers may be folded down to a volume smaller than a volume of the receptacle shape for improved portability, and when in the planar shape, the collapsible containers are relatively quickly and easily cleaned. This summary is provided to introduce simplified concepts of collapsible cookware systems, which are further described below in the Detailed Description. This summary is not intended to identify essential features of the claimed subject matter, nor is it intended for use in determining the scope of the claimed subject matter.

In one example, a collapsible cookware system includes a first member formed of a first material that may be foldable between a planar shape, a receptacle shape, and a collapsed shape.

In another example, a collapsible cookware system includes a first member formed of a first material and a second member formed of a second material different than the first material. The second member may be attached to a bottom surface of the first member. In this example, where the collapsible cookware system may include a second member attached to a bottom surface of the first member, the collapsible cookware system may be foldable between a planar shape, a receptacle shape, and a collapsed shape. In another example, a collapsible cookware system includes a first member formed of a first material that includes a plurality of creases arranged in the first member to fold the first member between a planar shape, a receptacle shape, and a collapsed shape.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example campground cooking environment involving a camp stove.

FIG. 2 illustrates a planar view of an example collapsible container having a first member that is in a planar shape that allows users to easily clean the collapsible container.

FIG. 3 illustrates a perspective view of the example collapsible container shown in FIG. 2 in a first fold position that allows the users to fold the first member shown in FIG. 2 between the planar shape shown in FIG. 2 and a receptacle shape shown in FIG. 7.

FIG. 4 illustrates a perspective view of the example collapsible container shown in FIG. 2 in a second fold position that allows the users to fold the first member shown in FIG. 2 between the planar shape shown in FIG. 2 and the receptacle shape shown in FIG. 7.

FIG. 5 illustrates a perspective view of the example collapsible container shown in FIG. 2 in a position that allows the users to fold the first member shown in FIG. 2 between the planar shape shown in FIG. 2 and the receptacle shape shown in FIG. 7.

FIG. 6 illustrates a perspective view of the example collapsible container shown in FIG. 2 in a third fold position that allows the users to fold the first member shown in FIG. 2 between the planar shape shown in FIG. 2 and the receptacle shape shown in FIG. 7.

FIG. 7 illustrates a perspective view of the example collapsible container shown in FIG. 2 in a fourth fold position that allows the users to fold the first member shown in FIG. 2 between the planar shape shown in FIG. 2 and the receptacle shape shown in FIG. 7.

FIG. 8 illustrates a perspective view of the example collapsible container shown in FIG. 2 in a first fold position that allows the users to fold the first member shown in FIG. 2 between the planar shape shown in FIG. 2 and a collapsed shape shown in FIG. 12.

FIG. 9 illustrates a perspective view of the example collapsible container shown in FIG. 2 in a second fold position that allows the users to fold the first member shown in FIG. 2 between the planar shape shown in FIG. 2 and the collapsed shape shown in FIG. 12.

FIG. 10 illustrates a perspective view of the example collapsible container shown in FIG. 2 in a third fold position that allows the users to fold the first member shown in FIG. 2 between the planar shape shown in FIG. 2 and the collapsed shape shown in FIG. 12.

FIG. 11 illustrates a perspective view of the example collapsible container shown in FIG. 2 in a fourth fold position that allows the users to fold the first member shown in FIG. 2 between the planar shape shown in FIG. 2 and the collapsed shape shown in FIG. 12.

FIG. 12 illustrates a perspective view of the example collapsible container shown in FIG. 2 in the collapsed shape shown in FIG. 12.

FIG. 13 illustrates a section view taken along section A-A shown in FIG. 2.

### DETAILED DESCRIPTION

### Overview

This disclosure is directed to collapsible cookware systems that fold between a planar shape, a receptacle shape, and a collapsed shape. For example, the collapsible cookware systems may include a first member formed of a first material, where the first member may fold between a planar shape, a receptacle shape, and a collapsed shape. For example, the first member may be a sheet, a parallelogram sheet, a rectangular sheet, etc. formed of a composite material that may have a plurality of creases arranged in the composite material for folding the first member between the planar shape, the receptacle shape, and the collapsed shape. Moreover, the collapsible cookware systems may include a second member formed of a second material different than the first material and attached to a bottom surface of the first member. The second member may be a plate, a parallelogram plate, or a rectangular plate that may have a footprint larger than a footprint of the first member when the first member is folded in the receptacle shape. In this way, the second member of the collapsible cookware system at least partly shields the first member from direct exposure to a heat source (e.g., a flame, a blaze, a fire, etc.) when the collapsible cookware system is arranged on a stove (e.g., camp stove, camp burner, a burner, etc.) to heat a liquid and/or solid contained in the collapsible cookware system. While this application describes various embodiments of collapsible cookware systems used in the field of camping, this is by way of example and not limitation. For example, the collapsible cookware systems may be used in other fields such as home applications, restaurant applications, military applications, travel applications, survival applications, etc.

The collapsible cookware systems may include a collapsible container foldable between the planar shape, the receptacle shape, and the collapsed shape. For example, the collapsible container may include a first member formed of a first material that may be folded from the planar shape to the receptacle shape for cooking a liquid and/or a solid, folded from the planar shape to the collapsed shape for more convenient portability, or folded from the receptacle shape to the planar shape for quick and easy cleaning. In the example where the collapsible container includes a second member formed of a second material different than the first material and attached to a bottom surface of the first member, the second member can have a footprint larger than a footprint of a bottom surface of first member when the first member is in the receptacle shape. For example, the second member may have a footprint larger than the footprint of the bottom surface of the first member when the first member is in the receptacle shape to shield the first member from a heat source (e.g., a flame, a blaze, a fire, etc.) when the collapsible container is arranged on a stove (e.g., camp stove, camp burner, a burner, etc.) to heat a liquid and/or solid contained in the first member folded in the receptacle shape. The second material may comprise a material resistant to damage by fire up to about 1500 degrees centigrade.

Further, the collapsible cookware system may include a plurality of creases arranged in the first member to fold the first member between the planar shape, the receptacle shape, and the collapsed shape. For example, when the first member is folded in the receptacle shape, the receptacle shape may include a bottom surface and a wall fixed to a footprint of the bottom surface and the plurality of creases may comprise about four creases arranged in the bottom surface and about twelve creases arranged in the wall. When folding the first member between the planar shape to the receptacle shape, the four creases arranged in the bottom surface may provide for folding a first portion of the wall, a second portion of the wall, a third portion of the wall, or a fourth portion of the wall orthogonally relative to the bottom surface, and the twelve creases arranged in the wall may provide for folding the first portion of the wall, the second portion of the wall, the third portion of the wall, or the fourth portion of the wall orthogonally relative to each other such that the first portion, the second portion, the third portion, or the fourth portion of the wall project vertically from the bottom surface. When folding the first member between the planar shape to the collapsed shape, the four creases arranged in the bottom surface may provide for folding the first portion of the wall, the second portion of the wall, the third portion of the wall, or the fourth portion of the wall acutely relative to the bottom surface such that the first portion of the wall, the second portion of the wall, the third portion of the wall, or the fourth portion of the wall are stacked on the bottom surface.

The collapsible cookware system may include a fastener arranged in the first member to secure the folded first member in the receptacle shape. For example, a snap fastener may be arranged in the first member and a corresponding hole may be arranged in the first member, where the corresponding hole may receive the snap fastener, and the snap fastener may secure the folded first member in the receptacle shape.

### Illustrative Collapsible Cookware Systems

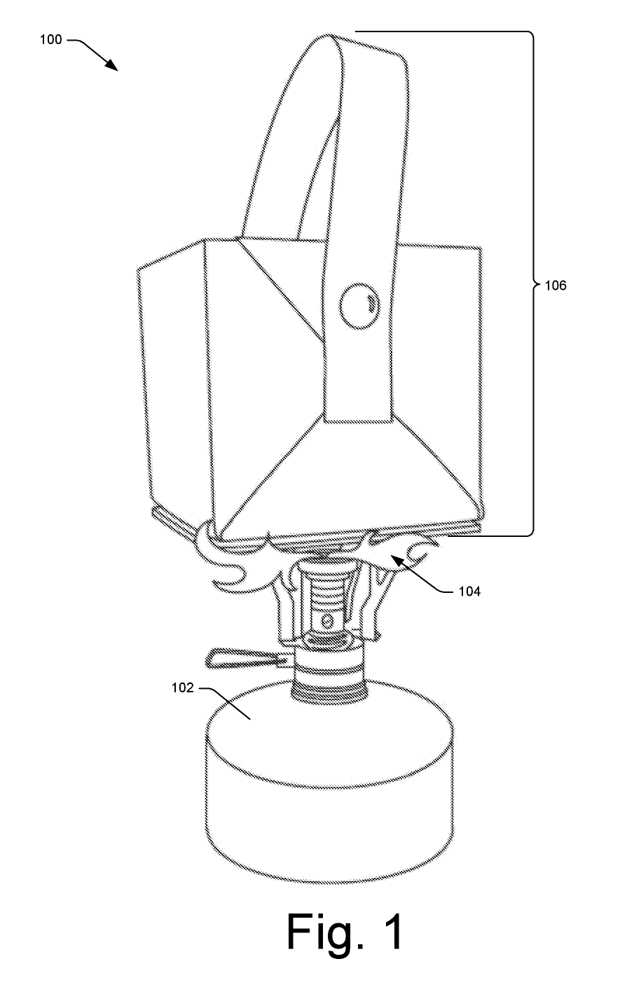

FIG. 1 illustrates an example campground cooking environment 100 involving a camp stove 102. FIG. 1 illustrates a campground cooking environment 100 of the camp stove 102 applying a heat source 104 (e.g., a flame, a blaze, a fire, etc.) to a collapsible container 106 to heat a liquid and/or solid contained in the collapsible container 106. Further, while applying a heat source 104 (e.g., a flame, a blaze, a fire, etc.) to a collapsible container 106 to heat a liquid and/or solid contained in the collapsible container 106, the heat source 104 may be applied directly to the collapsible container 106. For example, the collapsible container 106 may rest on supports (e.g., arms, grill, grate, lattice, etc.) of the stove 102 directly above the heat source 104. While FIG. 1 illustrates a campground cooking environment 100 where the collapsible container 106 rests on the camp stove 102, other types of campground cooking environments may occur. For example, a campground cooking environment may occur where the collapsible container 106 is arranged above a campfire, fire bowl, fire pit, etc. In most cases, the collapsible container 106 is positioned to be directly in contact with a heat source. Further, while FIG. 1 illustrates the camp stove 102 comprising a canister type stove, the camp stove 102 may be a liquid-fuel type stove, an alternative-fuel stove, solid-fuel tablet stove, integrated canister type stove, etc. Further, the heat source 104 may not be directly applied to the collapsible container 106. For example, the heat source 104 may be applied indirectly to the collapsible container 106 via conducting heat through at least a first body (e.g., a pan, a griddle, a pot, etc.) to the collapsible container 106.

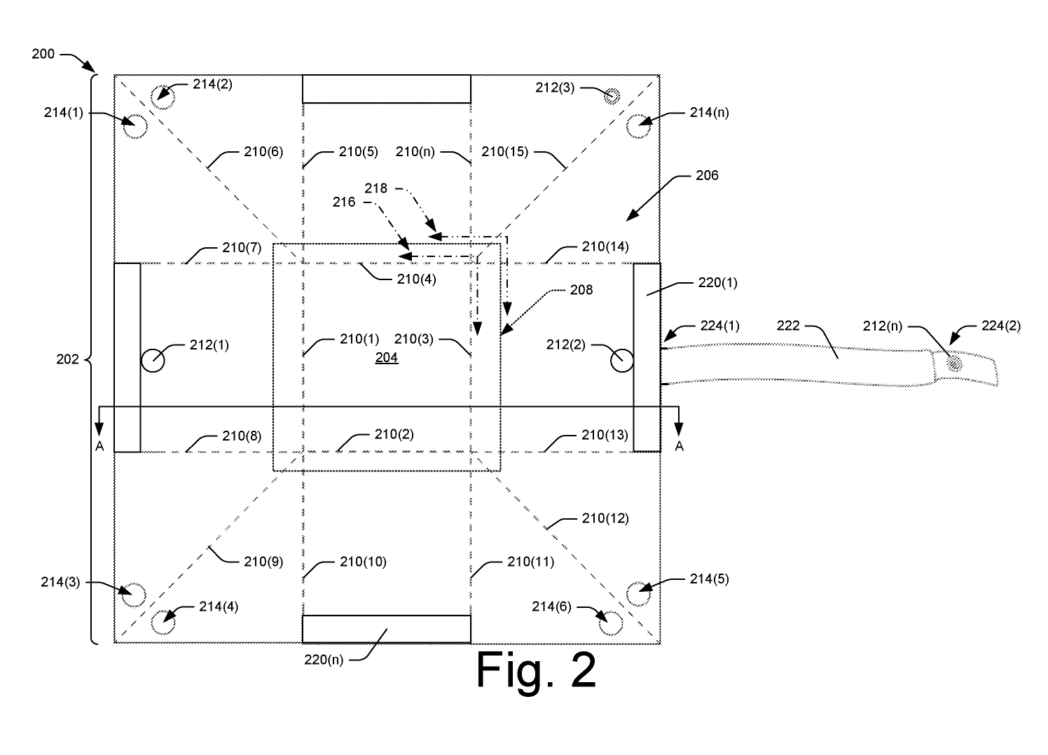

FIG. 2 illustrates a planar view 200 of an example collapsible container 202. The example collapsible container 202 may be the same as the collapsible container 106 illustrated in FIG. 1. FIG. 2 illustrates the collapsible container 202 may include a first member 204 that is in a planar shape 206. The planar shape 206 of the first member 204 may provide for a user to easily clean the collapsible container 202. For example, when the first member 204 is in the planar shape 206 the first member 204 may be void of pockets, corners, notches, edges, etc., that may collect and retain liquids and/or solids. Because the first member 204 may be void of pockets, corners, notches, edges, etc., when in the planar shape 206, the first member 204 may be less difficult for a user to vacate liquids and/or solids, thereby easing the cleaning process compared to cleaning conventional pots, bowls, or cups.

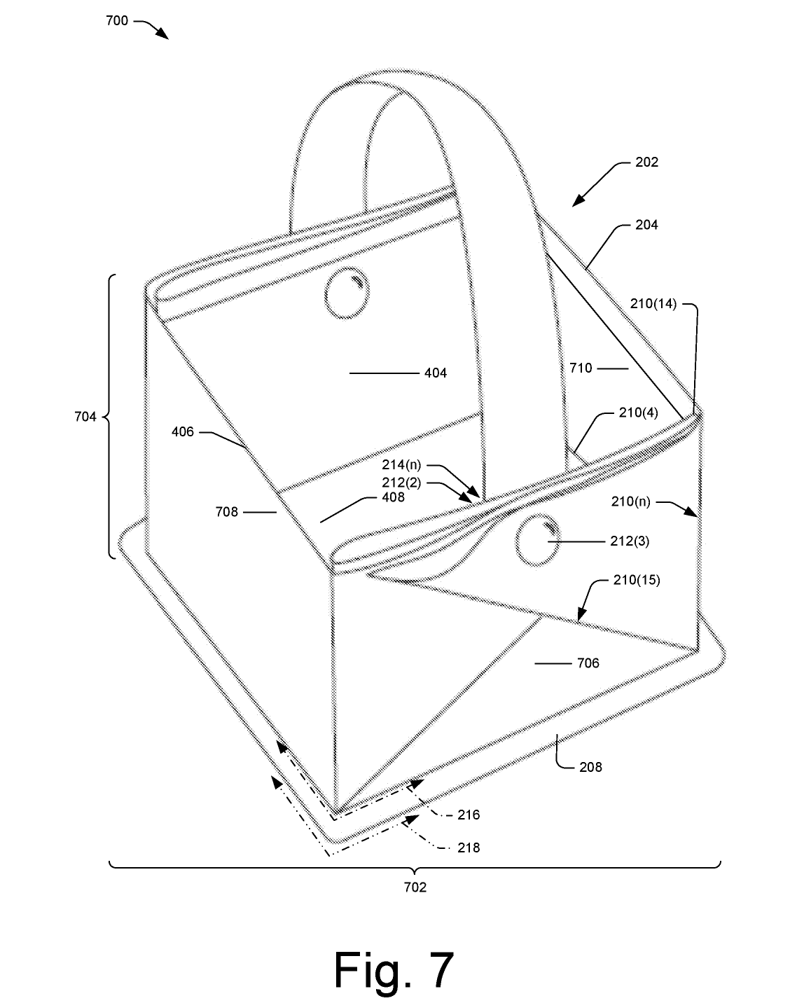

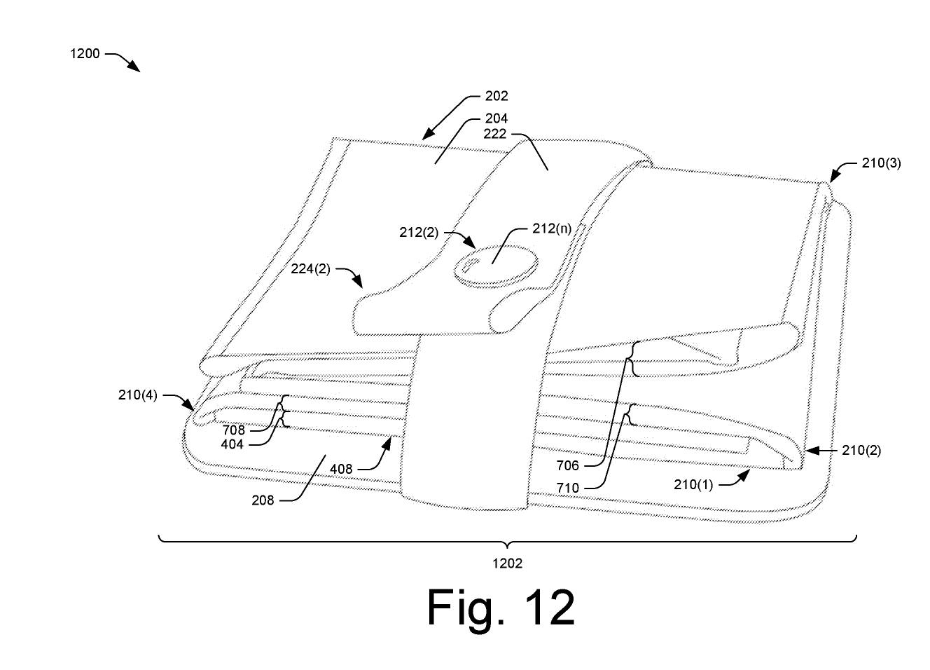

The first member 204 may be formed of a first material, and may be foldable between the planar shape 206, a receptacle shape (illustrated in FIG. 7), and a collapsed shape (illustrated in FIG. 12). For example, the first member 204 may be formed of a composite material that may be substantially deformable, flexible, pliant, etc. and substantially not rigid to provide for folding between the planar shape 206, the receptacle shape, and the collapsed shape. For example, the composite material may be a fiber-reinforced plastic coated in a fluorocarbon-based polymer (e.g., a fiberglass coated in PTFE), a synthetic fiber coated in a fluorocarbon-based polymer (e.g., an aramid fiber coated in PTFE), etc. that may be substantially not rigid and may be substantially deformable, flexible, pliant, etc. to provide for folding between the planar shape 206, the receptacle shape, and the collapsed shape. Moreover, the fluorocarbon-based polymer (e.g., PTFE) coating may provide for a non-stick surface. For example, the PTFE coating may reduce ability tendency of other materials being heated (e.g., liquids and/or solids) to stick to the surface of the first member 204. The PTFE coating may further simplify cleaning the collapsible container 202.

In one example, the first member 204 may have a length of about 12 inches (30 centimeters) and a width of about 12 inches (30 centimeters). In another example, the first member 204 may have a length of about 15 inches (38 centimeters) and a width of about 15 inches (38 centimeters). In another example, the first member 204 may have a length of about 18 inches (46 centimeters) and a width of about 18 inches (46 centimeters).

FIG. 2 illustrates a second member 208 (depicted in a dashed hidden line) may be attached to a bottom surface of the first member 204. The second member 208 may be formed of a second material different than the first material. The second material may comprise a material resistant to damage by fire up to about 1500 degrees centigrade or more, such as, for example, a metal, a ceramic, etc. For example, a metal material may be an aluminum alloy, a steel alloy, or a titanium alloy resistant to damage by fire up to about 1500 degrees centigrade. The second member 208 may be attached to the first member via rivets, threaded fasteners, adhesives, snap-fit fasteners, press-fit fasteners, etc.

In one example, the second member 208 may have a length of about 4 inches (10 centimeters) and a width of about 5 inches (13 centimeters). In another example, the second member 208 may have a length of about 6 inches (15 centimeters) and a width of about 6 inches (15 centimeters). In one example, the second member 208 may have a thickness of about ¼ inches (0.6 centimeters).

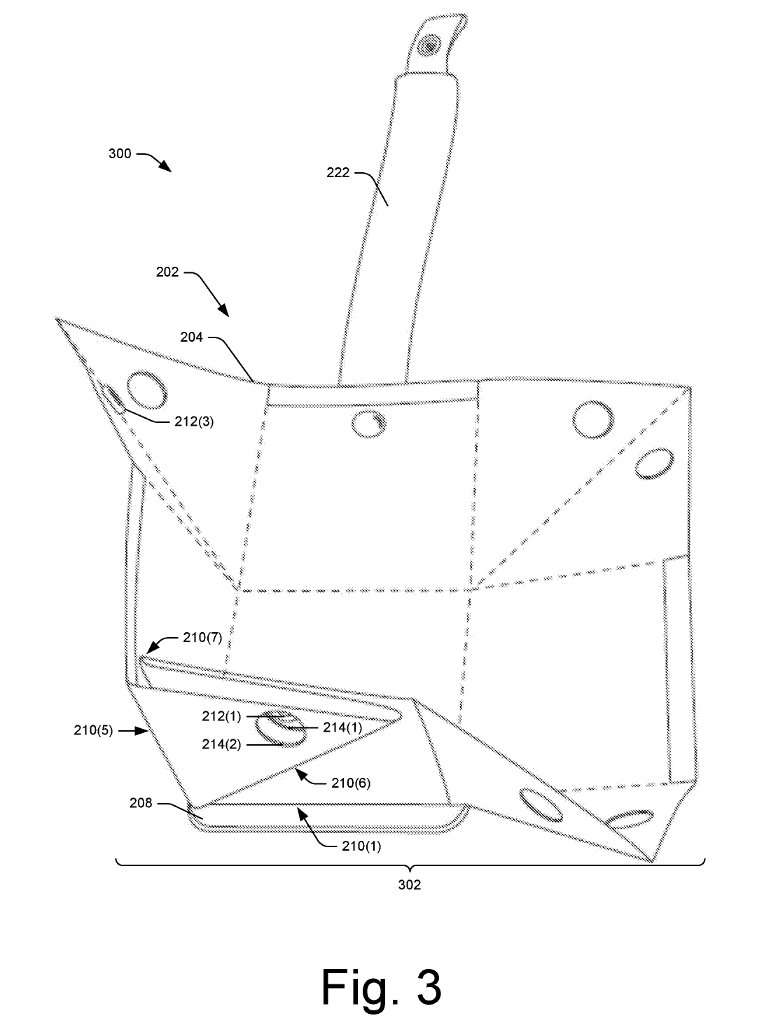

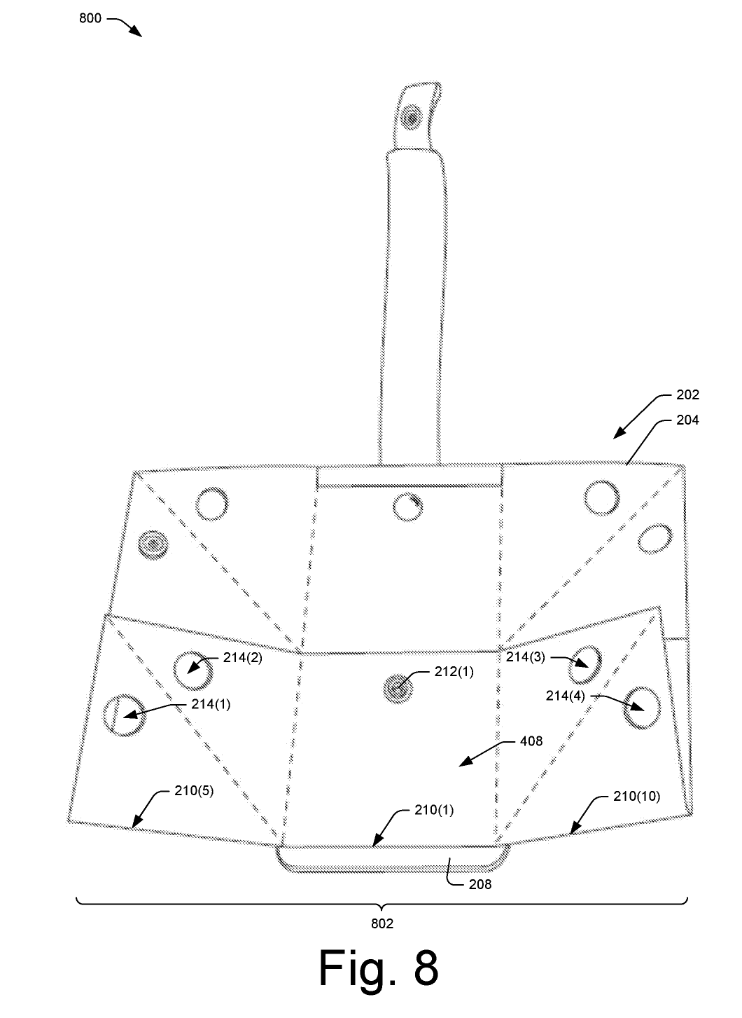

FIG. 2 illustrates a plurality of creases 210(1), 210(2), 210(3), 210(4), 210(5), 210(6), 210(7), 210(8), 210(9), 210(10), 210(11), 210(12), 210(13), 210(14), 210(15), and 210(n), may be arranged in the first member 204. The plurality of creases 210(1)-210(n) may provide for folding the first member 204 between the planar shape 206, the receptacle shape, and the collapsed shape. For example, the plurality of creases 210(1)-210(n) may include about four creases 210(1)-210(4) arranged in a bottom surface and about twelve creases 210(5)-210(n) arranged in a wall when the first member 204 is in the receptacle shape. For example, and as described in detail with regard to FIGS. 3-7, when folding the first member 204 between the planar shape 206 to the receptacle shape (illustrated in FIG. 7), the four creases 210(1)-210(4) arranged in the bottom surface may provide for folding a first portion of the wall, a second portion of the wall, a third portion of the wall, or a fourth portion of the wall orthogonally relative to the bottom surface. The twelve creases 210(5)-210(n) arranged in the wall may provide for folding the first portion of the wall, the second portion of the wall, the third portion of the wall, or the fourth portion of the wall orthogonally relative to each other such that the first portion of the wall, the second portion of the wall, the third portion of the wall, or the fourth portion of the wall project vertically from the bottom surface. Further, and as described in detail with regard to FIGS. 8-12, when folding the first member 204 between the planar shape 206 to the collapsed shape (illustrated in FIG. 12), the four creases 210(1)-210(4) arranged in the bottom surface may provide for folding the first portion of the wall, the second portion of the wall, the third portion of the wall, or the fourth portion of the wall acutely relative to the bottom surface such that the first portion of the wall, the second portion of the wall, the third portion of the wall, or the fourth portion of the wall are stacked on the bottom surface. Further, the plurality of creases 210(1)-210(n) may provide for a user to visualize where and/or how to fold the first member 204.

FIG. 2 illustrates fasteners 212(1), 212(2), and 212(n) may be arranged in the first member 204 and/or a strap, and a plurality of corresponding of holes 214(1), 214(2), 214(3), 214(4), 214(5), 214(6), and 214(n) may be arranged in the first member 204. One or more corresponding holes of the plurality of holes 214(1)-214(n) may receive a fastener of the fasteners 212(1)-212(n), such that the fastener may secure the first member 204 in the receptacle shape. For example, and as described in detail with regard to FIGS. 3-7, when folding the first member 204 between the planar shape 206 to the receptacle shape (illustrated in FIG. 7), corresponding holes 214(1)-214(4) may receive fasteners 212(1) and 212(n), and corresponding holes 214(5)-214(n) may be receive fasteners 212(2) and 212(3). The fasteners 212(1) may be a snap fastener (e.g., interlocking fastener), a snap-fit fastener, a press-fit fastener, a button, a clasp, a hook, a buckle, a zipper, a hook-and-loop fastener, etc. arranged to secure the folded first member in the receptacle shape.

When the first member 204 is in the receptacle shape, the bottom surface of the first member 204 may have a first footprint 216 smaller than a second footprint 218 of the second member 208. For example, and described in detail with regard to FIG. 7, when the first member 204 is in the receptacle shape, the second member 208 may have the second footprint 218 that may be larger in size (e.g., length and width, diameter, perimeter, etc.) than a size (e.g., length and width, diameter, perimeter, etc.) of the first footprint 216 to provide for the second member 208 to shield the first member 204 from direct exposure to a heat source (e.g., a flame, a blaze, a fire, etc.). For example, when the first member 204 is in the receptacle shape and arranged on the camp stove 102 to heat (e.g., cook) a liquid and/or solid (e.g., sustenance) contained in the first member 204 folded in the receptacle shape, the larger second footprint 218 may shield the first member 204 from the heat source 104 while heating the liquid and/or solid.

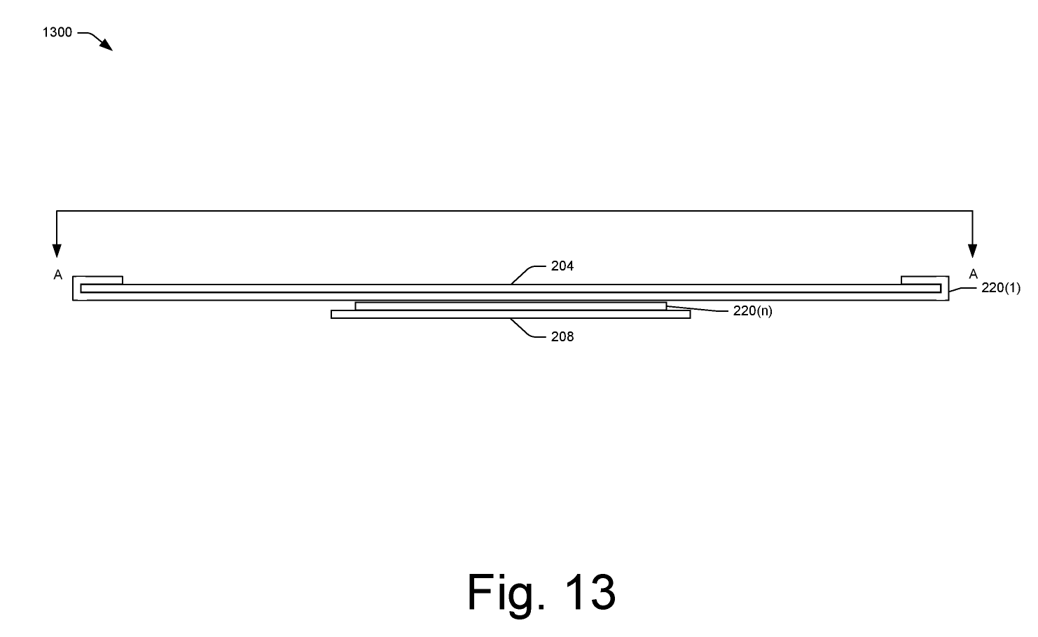

FIG. 2 illustrates one or more bands 220(1) and 220(n) attached to the first member 204 (cross-section A-A illustrated in FIG. 13). In one example, each of the one or more bands 220(1) and 220(n) may be individual strips formed of the same composite material forming the first member 204. For example, each of the one or more bands 220(1) and 220(n) may be a strip of the fiber-reinforced plastic coated in a fluorocarbon-based polymer (e.g., a fiberglass coated in Polytetrafluoroethylene (PTFE)), a synthetic fiber coated in a fluorocarbon-based polymer (e.g., an aramid fiber coated in PTFE), etc. that may be substantially not rigid and may be substantially deformable, flexible, pliant, etc. Each of the one or more bands 220(1) and 220(n) may have a first end opposite a second end, the first and second ends may be attached to a wall of the first member. The first and second ends of the one or more bands 220(1) and 220(n) may be attached to the wall of the first member via a weld, an adhesive, a stitching, fastener, etc. In one example a portion of each of the first and second ends of the one or more bands 220(1) and 220(n) may be folded over the first member 204. For example, about a ½ inch (1 centimeter) of each of the first and second ends of the one or more bands 220(1) and 220(n) may be folded over an edge of the first member 204 and attached to the first member 204. While FIG. 2 illustrates the one or more bands 220(1) and 220(n) being a strip of the fiber-reinforced plastic coated in a fluorocarbon-based polymer (e.g., a fiberglass coated in PTFE), a synthetic fiber coated in a fluorocarbon-based polymer (e.g., an aramid fiber coated in PTFE), the one or more bands 220(1) and 220(n) may be formed of a substantially rigid material. For example, the one or more bands 220(1) and 220(n) may be formed of an aluminum alloy, a steel alloy, a titanium alloy, a plastic, a composite, a ceramic, etc. In this example where the one or more bands 220(1) and 220(n) may be formed of a substantially rigid material, one or more hinges may be arranged with the one or more bands 220(1) and 220(n) to provide for folding the first member 204. For example, one or more hinges may be arranged proximate to the creases 210(1), 210(2), 210(3), and 210(4) to provide for the one or more bands 220(1) and 220(n) to be pivotably moveable to provide for folding the first member 204 between the planar shape 206, the receptacle shape, and the collapsed shape.

A portion of each of the one or more bands 220(1) and 220(n) arranged between the first end and the second end may be disposed adjacent to the bottom surface of the first member 204. A portion of one or more of the one or more bands 220(1) and 220(n) arranged between the first end and the second end may not be attached to the bottom surface of the first member 204. The portion of the one or more of the one or more bands 220(1) and 220(n) not attached to the bottom surface of the first member 204 may be arranged to reside adjacent the bottom surface of the first member 204. The portion of the one or more bands 220(1) and 220(n) not attached to the first member and arranged adjacent to the bottom surface of the first member 204 may provide for attaching the second member 208 to the bottom surface of the first member 204. For example, the portion of the one or more bands 220(1) and 220(n) not attached to the first member 204 may provide for riveting the second member 208 to the portion of the one or more bands 220(1) and 220(n) adjacent to the bottom surface of the first member 204. In one example, the second member 208 may be attached to the portion of one of the one or more bands 220(1) and 220(n) via rivets, threaded fasteners, adhesives, snap-fit fasteners, press-fit fasteners, etc. In another example, the second member 208 may be directly attached to the bottom surface of the first member 204.

The one or more bands 220(1) and 220(n) may provide for increasing a stiffness of the first member 204. For example, the one or more bands 220(1) and 220(n) may stiffen a first portion of a wall, a second portion of the wall, a third portion of the wall, and/or a fourth portion of the wall when the first member 204 is folded in the receptacle shape shown in FIG. 7.

FIG. 2 illustrates the collapsible container 202 may include a strap 222. The strap 222 may have a first end 224(1) opposite a second end 224(2). The first end 224(1) may be attached to the first member 204 and the second end 224(2) may be free and attachable (e.g., coupleable) to the first member 204. For example, the first end 224(1) of the strap 222 may be attached via the fastener 212(2) to the first member 204, and the second end 224(2) of the strap 222 may include the fastener 212(n) fixed to the second end 224(2) of the strap 222 to attach the second end 224(2) of the strap 222 to the fastener 212(1) fixed to the first member 204. The strap 222 may be formed of a composite material having a thickness to provide an amount of rigidity to hold the strap 222 in an elevated position above the wall of the receptacle shape of the folded first member 204. The composite material forming the strap 222 may be substantially the same composite material forming the first member 204. The strap 222 may include a wrap, a cover, a binding, etc. arranged on the strap 222. For example, the strap 222 may include a wrap, a cover, a binding, etc. arranged around the strap 222 to provide an ergonomic gripping portion so that a hand of a user may grip the strap more efficiently and more safely. For example, the strap 222 may be further wrapped in paracord.

The first member 204 may comprise a sheet, a parallelogram sheet, a polygonal sheet, a rectangular sheet, formed of the composite material. For example, the first member 204 may comprise a rectilinear sided sheet. For example, the first member 204 may comprise a four-sided rectilinear sheet with opposite sides being parallel. In another example, the first member 204 may comprise a curvilinear sided sheet (not shown).

The second member 208 may comprise a plate, a parallelogram plate, a polygonal plate, a rectangular plate, formed of the material resistant to damage by fire up to about 1500 degrees centigrade. For example, the second member 208 may comprise a rectilinear sided plate formed of a metal material that may be resistant to damage by fire up to about 1500 degrees centigrade. For example, the second member 208 may comprise a four-sided rectilinear plate with opposite sides parallel. In another example, the second member 208 may comprise curvilinear sided plate (not shown).

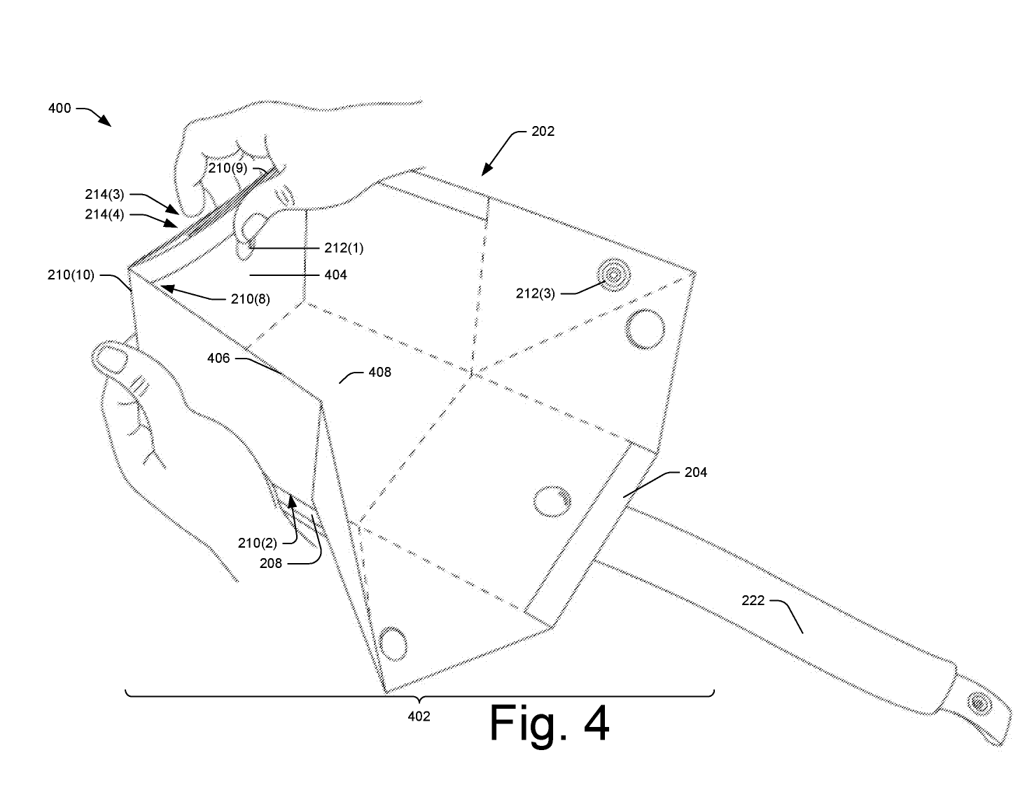

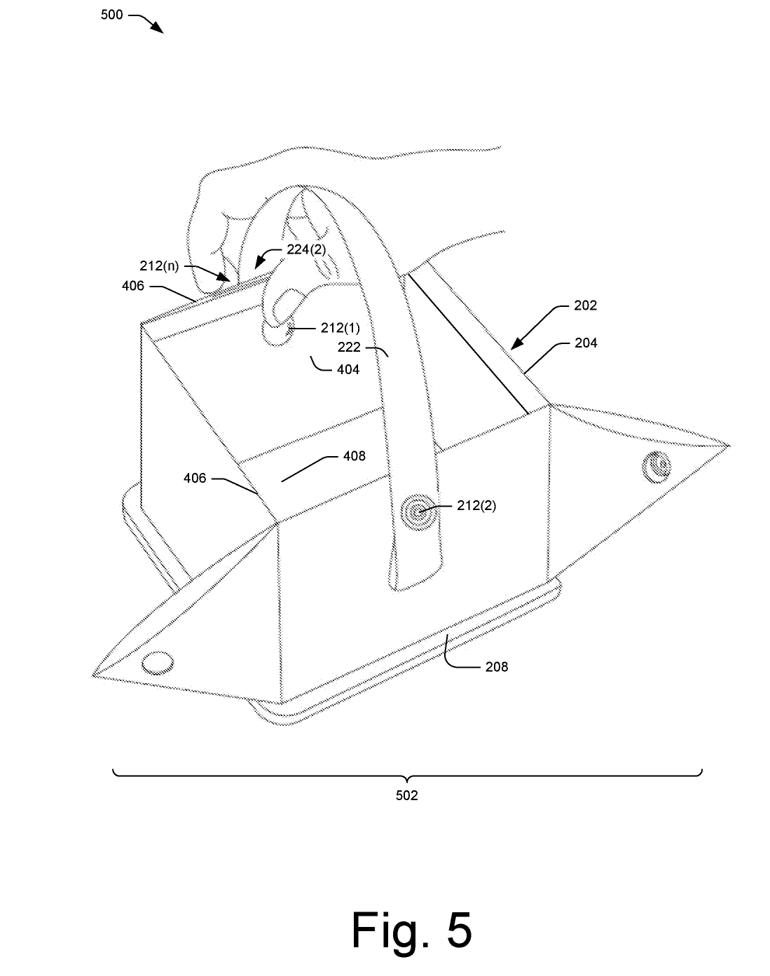

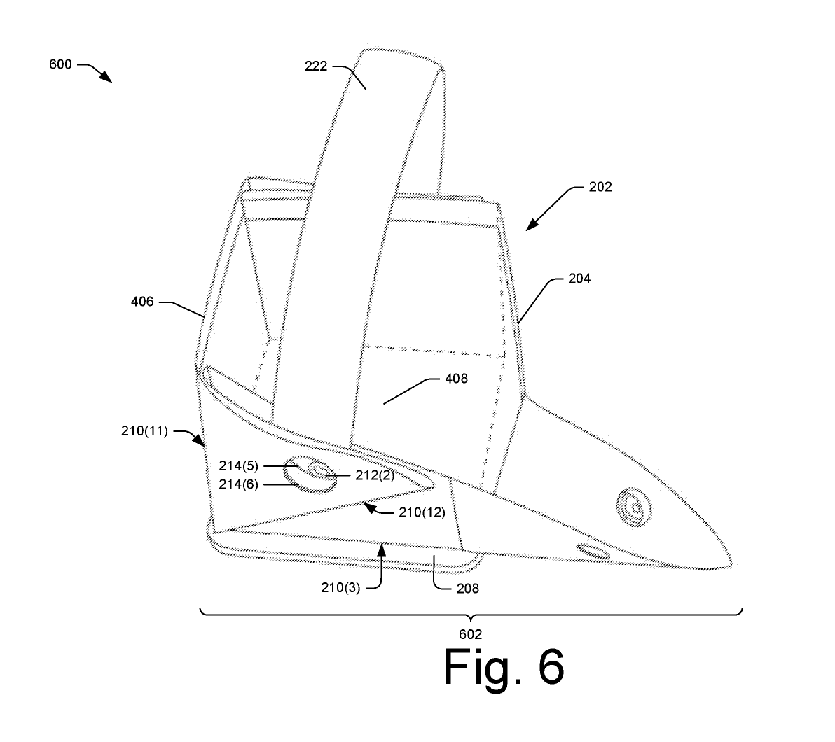

Generally, FIG. 3, FIG. 4, FIG. 5, FIG. 6, and FIG. 7 depict folding the first member 204 of the collapsible container 202 shown in FIG. 2. FIG. 3 illustrates a perspective view 300 of the collapsible container 202 shown in FIG. 2 in a first fold position 302. The first fold position 302 may be a first fold of a plurality of folds that allows a user to fold the first member 204 between the planar shape 206 shown in FIG. 2 and a receptacle shape shown in FIG. 7. The first fold position 302 may comprise the holes 214(1) and 214(2) receiving the fastener 212(1). For example, a portion of the first member 204 may be folded along the creases 210(1), 210(5), 210(6) and 210(7) such that the holes 214(1) and 214(2) receive the fastener 212(1).

FIG. 4 illustrates a perspective view 400 of the collapsible container 202 shown in FIG. 2 in a second fold position 402. The second fold position 402 may be a second fold of the plurality of folds that allows a user to fold the first member 204 between the planar shape 206 shown in FIG. 2 and the receptacle shape shown in FIG. 7. The second fold position 402 may comprise the holes 214(3) and 214(4) receiving the fastener 212(1). For example, a portion of the first member 204 may be folded along the creases 210(2), 210(8), 210(9) and 210(10) such that the holes 214(3) and 214(4) receive the fastener 212(1). While FIG. 3 illustrates the first fold and FIG. 4 illustrates the second fold, the first and second folds may be reversed. For example, the fold illustrated in FIG. 4 may take place first, followed by the fold illustrated in FIG. 3 taking place second.

FIG. 4 illustrates a first portion 404 of a wall 406. For example, the first fold position 302 together with the second fold position 402 may produce the first portion 404 of the wall 406. In another example, the first fold position 302 may produce the first portion 404 of the wall 406. In another example, the second fold position 402 may produce the first portion 404 of the wall 406. The first portion 404 of the wall 406 may project vertically from a bottom surface 408.

FIG. 5 illustrates a perspective view 500 of the example collapsible container 202 shown in FIG. 2 in a position 502 that allows a user to fold the first member 204 shown in FIG. 2 between the planar shape 206 shown in FIG. 2 and the receptacle shape shown in FIG. 7. The position 502 may comprise the strap 222 displaced adjacent to the first portion 404 of the wall 406, and the fastener 212(n) fixed to the second end 224(2) of the strap 222 and fastened to fastener 212(1). For example, the position 502 may comprise the fastener 212(n) fastened to the fastener 212(1) to secure the first fold position 302 together with the second fold position 402.

FIG. 6 illustrates a perspective view 600 of the example collapsible container 202 shown in FIG. 2 in a third fold position 602. The third fold position 602 may be a third fold of the plurality of folds that allows a user to fold the first member 204 shown in FIG. 2 between the planar shape 206 shown in FIG. 2 and the receptacle shape shown in FIG. 7. The third fold position 602 may comprise the holes 214(5) and 214(6) receiving the fastener 212(2). For example, a portion of the first member 204 may be folded along the creases 210(3), 210(11), 210(12) and 210(13) such that the holes 214(5) and 214(6) receive the fastener 212(3).

FIG. 7 illustrates a perspective view 700 of the collapsible container 202 shown in FIG. 2 in a fourth fold position 702. The fourth fold position 702 may be a fourth fold of the plurality of folds that allows a user to fold the first member 204 between the planar shape 206 shown in FIG. 2 and the receptacle shape 704. The fourth fold position 702 may comprise the hole 214(n) receiving the fastener 212(2). The fourth fold position 702 may also comprise the fastener 212(3) fastened to fastener 212(2). For example, a portion of the first member 204 may be folded along the creases 210(4), 210(14), 210(15) and 210(n) such that the hole 214(n) is received by the fastener 212(2) and the fastener 212(3) is fastened to fastener 212(2).

FIG. 7 illustrates a second portion 706 of the wall 406. For example, the fourth fold position 702 together with the third fold position 602 may produce the second portion 706 of the wall 406. In another example, the third fold position 602 may produce the second portion 706 of the wall 406. In another example, the fourth fold position 702 may produce the second portion 706 of the wall 406. The second portion 706 of the wall 406 may project vertically from the bottom surface 408.

FIG. 7 illustrates a third portion 708 of the wall 406 and a fourth portion 710 of the wall 406. The third portion 708 of the wall 406 may project vertically from the bottom surface 408, and the fourth portion 710 of the wall 406 may project vertically from the bottom surface 408. When the first member 204 is folded in the fourth fold position 702 and in the receptacle shape 704, the first portion 404 of the wall 406, the second portion 706 of the wall 406, the third portion 708 of the wall 406, and the fourth portion 710 of the wall 406 projecting vertically from the bottom surface 408 define the first footprint 216 of the first member 204. Each of the first portion 404, the second portion 706, the third portion 708, and the forth portion 708 may be fixed to the first footprint 216 and project vertically from the bottom surface 408. In one example, the wall 406 may have a height of about 4 inches (10 centimeters). In another example, the wall 406 may have a height of about 5 inches (13 centimeters). In another example, the wall 406 may have a height of about 6 inches (15 centimeters).

FIG. 7 illustrates the second member 208 may be attached to the bottom surface 408 of the first member 204. FIG. 7 illustrates the second footprint 218 of the second member 208 may be larger in size than the first footprint 216 of the bottom surface 408 and extend beyond the first footprint 216 when the first member 204 is folded in the fourth fold position 702 and in the receptacle shape 704. Because the second footprint 218 of the second member 208 is larger than the first footprint 216 of the bottom surface 408 of the first member 204 when the first member 204 is in the receptacle shape 704, the second member 208 may shield the first member 204 from the heat source 104.

While FIG. 7 illustrates the receptacle shape 704 comprising a parallelepiped shape, the receptacle shape 704 may not comprise a parallelepiped shape. For example, the receptacle shape 704 may comprise a curvilinear shape. The collapsible container 202 may further include a lid (not shown). In one example, the lid may be separate unit. The lid may be useable as a cover (e.g., an insulator, a heatsink, a pad, a hot pad, etc.) attachable to the second member 208. For example, the lid may be useable to cover the second member 208 subsequent to heating liquids or solids to protect a user while handling the collapsible container 202. In another example, the lid may be useable to cover the second member 208 when the first member 204 is folded in the collapsed shape shown in FIG. 12 for transporting the collapsible container 202.

FIG. 8 illustrates a perspective view 800 of the example collapsible container 202 shown in FIG. 2 in a first fold position 802 that allows a user to fold the first member 204 shown in FIG. 2 between the planar shape 206 shown in FIG. 2 and a collapsed shape shown in FIG. 12. The first fold position 802 may comprise a portion of the first member 204, including the holes 214(1), 214(2), 214(3), and 214(4) and the fastener 212(1), folded along the creases 210(1), 210(5), and 210(10) such that the portion of the first member 204 is stacked on the bottom surface 408 opposite the second member 208.

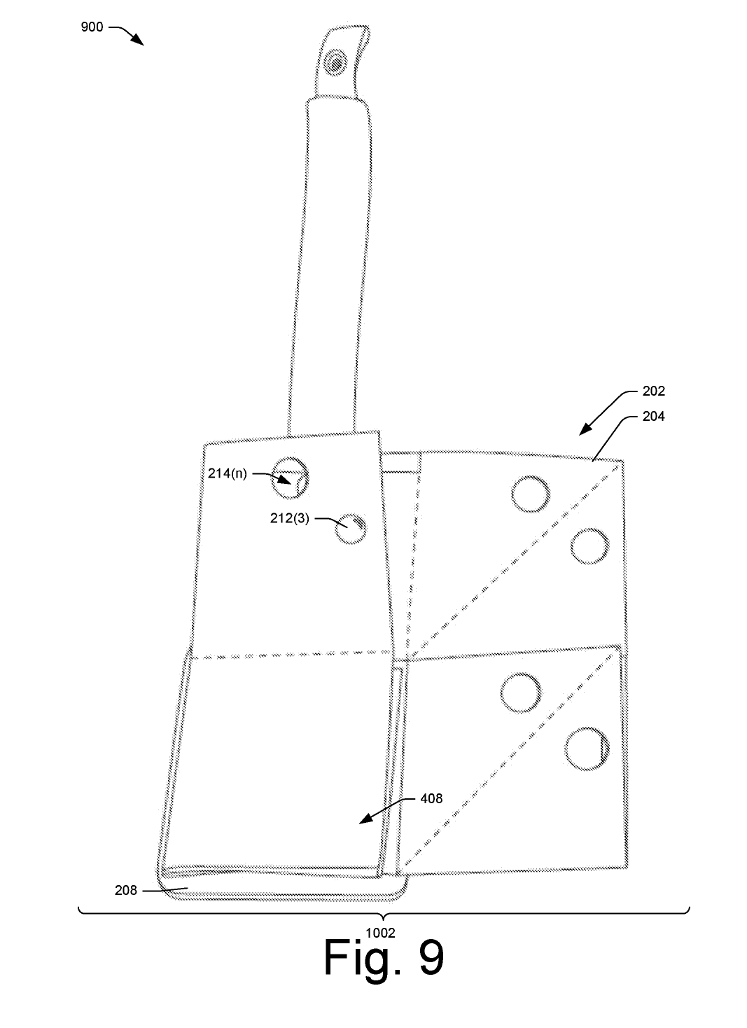

FIG. 9 illustrates a perspective view 900 of the example collapsible container 202 shown in FIG. 2 in a second fold position 902 that allows the users to fold the first member 204 shown in FIG. 2 between the planar shape 206 shown in FIG. 2 and the collapsed shape shown in FIG. 12. The second fold position 902 may comprise a portion of the first member 204, including the hole 214(n) and the fastener 212(3), folded along the creases 210(4), 210(7), and 210(14) such that the portion of the first member 204 is stacked on the bottom surface 408 opposite the second member 208.

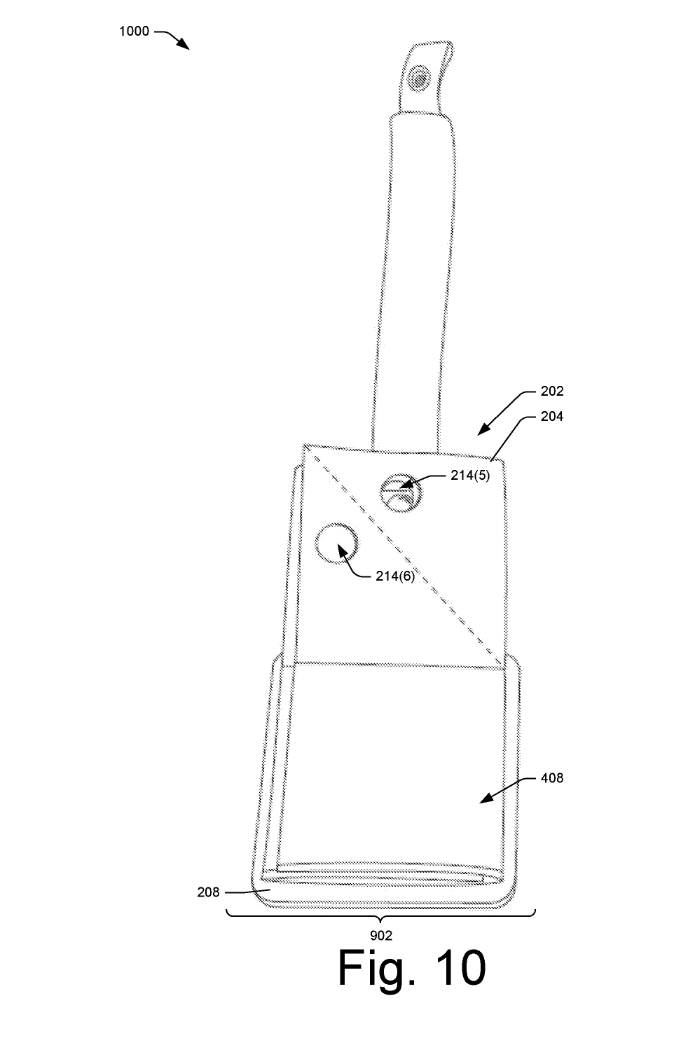

FIG. 10 illustrates a perspective view 1000 of the example collapsible container 202 shown in FIG. 2 in a third fold position 1002 that allows a user to fold the first member 204 shown in FIG. 2 between the planar shape 206 shown in FIG. 2 and the collapsed shape shown in FIG. 12. The third fold position 1002 may comprise a portion of the first member 204, including the holes 214(5) and 214(6), folded along the creases 210(2), 210(8), and 210(13) such that the portion of the first member 204 is stacked on the bottom surface 408 opposite the second member 208.

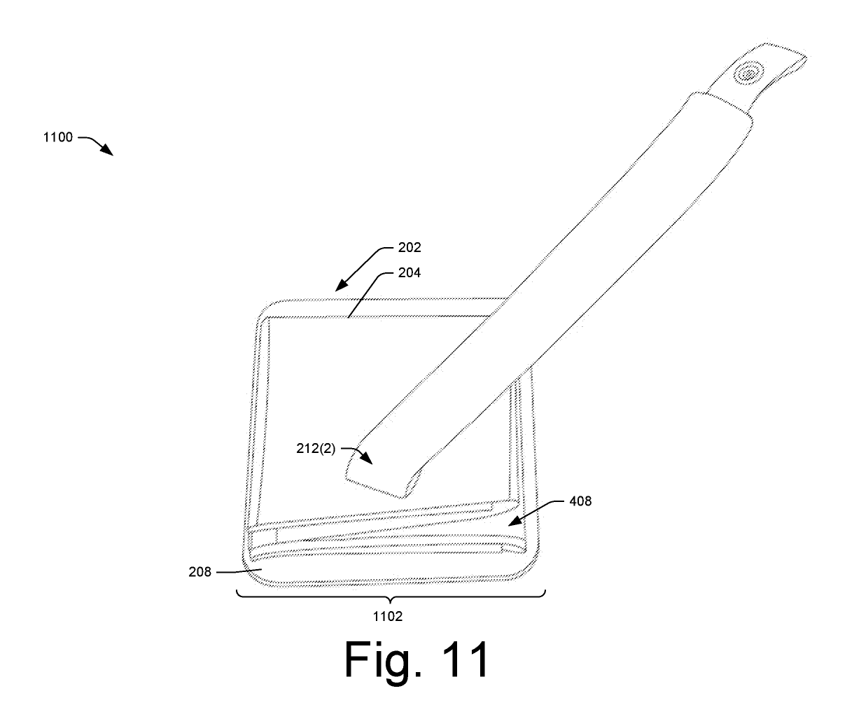

FIG. 11 illustrates a perspective view 1100 of the example collapsible container 202 shown in FIG. 2 in a fourth fold position 1102 that allows a user to fold the first member 204 shown in FIG. 2 between the planar shape 206 shown in FIG. 2 and the collapsed shape shown in FIG. 12. The forth fold position 1102 may comprise a portion of the first member 204, including fastener 212(2), folded along the creases 210(3), 210(11), and 210(n) such that the portion of the first member 204 is stacked on the bottom surface 408 opposite the second member 208.

FIG. 12 illustrates a perspective view 1200 of the example collapsible container 202 shown in FIG. 2 in the collapsed shape 1202. FIG. 12 illustrates the four creases 210(1), 210(2), 210(3) or 210(4) arranged in the bottom surface 408 may provide for folding the first portion 404 of the wall 406, the second portion 706 of the wall 406, the third portion 708 of the wall 406, and/or the fourth portion 710 of the wall 406 folded acutely relative to the bottom surface 408 such that the first portion 404 of the wall 406, the second portion 706 of the wall 406, the third portion 708 of the wall 406, and/or the fourth portion 710 of the wall 406 are stacked on the bottom surface 408.

FIG. 12 illustrates the fastener 212(n) may be fastened to the fastener 212(2) to secure the folded first member 204 in the collapsed shape 1202. In one example, when the collapsible container 202 is folded in the collapsed shape 1202, the collapsed shape 1202 may have a volume substantially smaller than a volume of the collapsible container 202 folded in the receptacle shape 704. For example, the collapsed shape 1202 may have a volume of about 94% smaller than the volume of the receptacle shape 704. For example, the collapsed shape 1202 may have a volume of about 5 cubic inches (73 cubic centimeters) (i.e., a length of about 4.5 inches (11 centimeters), a width of about 4.5 (11 centimeters), and a height of about 0.25 inches (0.6 centimeters)) and the receptacle shape 704 may have a volume of about 81 cubic inches (1210 centimeters) (i.e., a length of about 4.5 inches (11 centimeters), a width of about 4.5 (11 centimeters), and a height of about 4 inches (10 centimeters)). Because the collapsed shape 1202 may have a volume substantially smaller than a volume of the collapsible container 202 folded in the receptacle shape 704, the collapsed shape 1202 may provide for better portability than the receptacle shape 704.

FIG. 13 illustrates a section view 1300 taken along section A-A shown in FIG. 2. The section view 1300 illustrates the band 220(1) may be attached to the first member 204. For example, the entire length of the band 220(1) may be welded, adhered, stitched, etc. to the bottom surface of the first member 204. FIG. 13 illustrates a portion of the band 220(n) arranged between the first end and the second end may not be attached to the bottom surface of the first member 204. The portion of the band 220(n) not attached to the bottom surface of the first member 204 may be arranged to reside adjacent the bottom surface of the first member 204. FIG. 13 illustrates the second member 208 may be attached to the portion of the band 220(n) not attached to the first member and arranged adjacent to the bottom surface of the first member 204.

While FIGS. 8-12 illustrate the first member 204 being folded between the planar shape 206 to the collapsed shape 1202 via folding the horizontal fold portion of the first member 204 first, the first member 204 may be folded in different orders. For example, the first member 204 may be folded between the planar shape 206 to the collapsed shape 1202 via folding either of the vertical fold portions of the first member 204 first. For example, the first member 204 may be folded between the planar shape 206 to the collapsed shape 1202 via folding the left vertical fold portion (i.e., the fold portion along creases 210(4), 210(7), and 210(14), and having fastener 212(3) and holes 214(1), 214(2) and 214(n)) first, followed by the right vertical fold portion (i.e., the fold portion along creases 210(2), 210(8), and 210(13), and having holes 214(3), 214(4), 214(5) and 214(6)), or vice versa. Further, the order (e.g., arrangement, sequence, series, succession, etc.) of folding the first member 204 may control how the first portion 404, the second portion 706, the third portion 708, and the fourth portion 710 of the wall 406 are stacked on each other. For example, while FIG. 12 illustrates the second portion 706 of the wall 406 stacked on the fourth portion 710 of the wall 406, the fourth portion 710 of the wall 406 stacked on the third portion 708 of the wall 406, and the third portion 708 of the wall 406 stacked on the first portion 404 of the wall, the first portion 404, the second portion 706, the third portion 708, and the fourth portion 710 of the wall 406 may be stacked in a different order based on the folding order of the first member 204 from the planar shape 206 to the collapsed shape 1202.

### Example Clauses

A. A collapsible container for cooking sustenance comprising: a parallelogram sheet formed of a composite material, the parallelogram sheet to fold between a planar shape, a parallelepiped shape, and a collapsed shape, the parallelepiped shape including: a bottom surface having a parallelogram shaped footprint; and a wall having a first portion, a second portion, a third portion, and a fourth portion, each of the first portion, the second portion, the third portion, and the forth portion fixed to the parallelogram shaped footprint of the bottom surface; and a parallelogram plate formed of a metal material and attached to the bottom surface, wherein when the parallelogram sheet is in the collapsed shape, the first portion, the second portion, the third portion, and the fourth portion of the wall are stacked on the bottom surface opposite the parallelogram plate.

B. A collapsible container as clause A recites, wherein the parallelogram shaped footprint of the bottom surface is a first parallelogram shaped footprint, and the parallelogram plate has a second parallelogram shaped footprint larger than the first parallelogram shaped footprint of the bottom surface; and wherein when the parallelogram sheet is in the parallelepiped shape, and when the collapsible container is placed over a heat source, the parallelogram plate shields the parallelogram sheet from the heat source while cooking sustenance.

C. A collapsible container as any one or combination of clauses A-B recites, further comprising a plurality of creases arranged in the parallelogram sheet to fold the parallelogram sheet between the planar shape, the parallelepiped shape, and the collapsed shape.

D. A collapsible container as any one or combination of clauses A-C recites, further comprising a band formed of the composite material, the band having a first end opposite a second end, the first and second ends attached to the wall, and a portion of the band arranged between the first end and the second end being disposed adjacent to the bottom surface, and wherein the parallelogram plate is attached to the portion of the band disposed adjacent to the bottom surface.

E. A collapsible container as any one or combination of clauses A-D recites, wherein the composite material comprises a fiber-reinforced plastic coated in a fluorocarbon-based polymer, or a synthetic fiber coated in a fluorocarbon-based polymer.

F. A collapsible container as any one or combination of clauses A-E recites, wherein the metal material is an aluminum alloy, a steel alloy, or a titanium alloy.

G. A collapsible container as any one or combination of clauses A-F recites, further comprising a strap having a first end opposite a second end, at least one of the first end or the second end being attachable to the wall.

H. A collapsible container as clauses G recites, wherein the strap is formed of a composite material having a thickness, the thickness of the composite to provide an amount of rigidity to hold the strap in an elevated position above the wall of the parallelepiped shape.

I. A collapsible container as any one or combination of clauses A-H recites, further comprising a fastener arranged in the parallelogram sheet and a corresponding hole arranged in the parallelogram sheet, the corresponding hole to receive the fastener, and the fastener to secure the folded parallelogram in the parallelepiped shape.

J. A collapsible container comprising: a first member formed of a first material, the first member to fold between a planar shape, a receptacle shape, and a collapsed shape, the receptacle shape including: a bottom surface having a footprint; and a wall having a first portion, a second portion, a third portion, and a fourth portion, each of the first portion, the second portion, the third portion, and the forth portion fixed to the footprint; and a second member formed of a second material different than the first material and attached to the bottom surface, wherein when the first member is in the collapsed shape, the first portion, the second portion, the third portion, and the fourth portion of the wall are stacked on the bottom surface opposite the second member.

K. A collapsible container as clause J recites, wherein the footprint of the bottom surface is a first footprint, and the second member has a second footprint larger than the first footprint; and wherein when the first member is in the receptacle shape, the second member shields the first member from a heat source.

L. A collapsible container as any one or combination of clauses J-K recites, wherein the first member comprises a polygonal sheet.

M. A collapsible container as any one or combination of clauses J-L recites, wherein the second member comprises a polygonal plate.

N. A collapsible container as any one or combination of clauses J-M recites, wherein the first material comprises a composite material, and the second material comprises a material resistant to damage by fire up to about 1500 degrees centigrade.

O. A collapsible container as any one or combination of clauses J-N recites, further comprising a plurality of creases arranged in the first member to fold the first member between the planar shape, the parallelepiped shape, and the collapsed shape.

P. A collapsible container as any one or combination of clauses J-O recites, further comprising a strap having a first end opposite a second end, at least one of the first end or the second end being attachable to the wall.

Q. A collapsible container for cooking sustenance comprising: a sheet including a plurality of creases arranged in the sheet to fold the sheet between a planar shape, a receptacle shape, and a collapsed shape, the receptacle shape including: a bottom surface having a footprint; and a wall having a first portion, a second portion, a third portion, and a fourth portion, each of the first portion, the second portion, the third portion, and the forth portion fixed to the footprint; and a plate attached to the bottom surface, wherein when the sheet is in the collapsed shape, the first portion, the second portion, the third portion, and the fourth portion of the wall are stacked on the bottom surface opposite the plate.

R. A collapsible container as clause Q recites, wherein the plurality of creases comprises about four creases arranged in the bottom surface.

S. A collapsible container as any one or combination of clauses Q-R recites, wherein the plurality of creases comprises about twelve creases arranged in the wall.

T. A collapsible container as any one or combination of clauses Q-S recites, wherein, the footprint of the bottom surface is a first footprint, and the plate has a second footprint larger than the first footprint; and wherein when the sheet is in the receptacle shape, the plate shields the sheet from a heat source while cooking sustenance.

As will be apparent to those skilled in the art, various modifications, adaptations and variations of the foregoing specific disclosure can be made without departing from the scope of the invention claimed herein.

### CONCLUSION

Although the invention has been described in language specific to structural features and/or methodological acts, it is to be understood that the invention is not necessarily limited to the specific features or acts described. Rather, the specific features and acts are disclosed as illustrative forms of implementing the invention. For example, while embodiments are described having certain shapes, sizes, and configurations, these shapes, sizes, and configurations are merely illustrative.

What is claimed is:

1. A collapsible container for cooking sustenance comprising:
a parallelogram sheet formed of a composite material, the parallelogram sheet to fold between a planar shape, a parallelepiped shape, and a collapsed shape, the parallelepiped shape including:
a bottom surface having a parallelogram shaped footprint; and
a wall having a first portion, a second portion, a third portion, and a fourth portion, each of the first portion, the second portion, the third portion, and the forth portion fixed to the parallelogram shaped footprint of the bottom surface; and
a parallelogram plate formed of a metal material and attached to the bottom surface,
wherein when the parallelogram sheet is in the collapsed shape, the first portion, the second portion, the third portion, and the fourth portion of the wall are stacked on the bottom surface opposite the parallelogram plate.

2. The collapsible container of claim 1, wherein the parallelogram shaped footprint of the bottom surface is a first parallelogram shaped footprint, and the parallelogram plate has a second parallelogram shaped footprint larger than the first parallelogram shaped footprint of the bottom surface; and
wherein when the parallelogram sheet is in the parallelepiped shape, and when the collapsible container is placed over a heat source, the parallelogram plate shields the parallelogram sheet from the heat source while cooking sustenance.

3. The collapsible container of claim 1, further comprising a plurality of creases arranged in the parallelogram sheet to fold the parallelogram sheet between the planar shape, the parallelepiped shape, and the collapsed shape.

4. The collapsible container of claim 1, further comprising a band formed of the composite material, the band having a first end opposite a second end, the first and second ends attached to the wall, and a portion of the band arranged between the first end and the second end being disposed adjacent to the bottom surface, and
wherein the parallelogram plate is attached to the portion of the band disposed adjacent to the bottom surface.

5. The collapsible container of claim 1, wherein the composite material comprises a fiber-reinforced plastic coated in a fluorocarbon-based polymer, or a synthetic fiber coated in a fluorocarbon-based polymer.

6. The collapsible container of claim 1, wherein the metal material is an aluminum alloy, a steel alloy, or a titanium alloy.

7. The collapsible container of claim 1, further comprising a strap having a first end opposite a second end, at least one of the first end or the second end being attachable to the wall.

8. The collapsible container of claim 7, wherein the strap is formed of a composite material having a thickness, the thickness of the composite to provide an amount of rigidity to hold the strap in an elevated position above the wall of the parallelepiped shape.

9. The collapsible container of claim 1, further comprising a fastener arranged in the parallelogram sheet and a corresponding hole arranged in the parallelogram sheet, the corresponding hole to receive the fastener, and the fastener to secure the folded parallelogram in the parallelepiped shape.

10. A collapsible container comprising:
a first member formed of a first material, the first member to fold between a planar shape, a receptacle shape, and a collapsed shape, the receptacle shape including:
a bottom surface having a footprint; and
a wall having a first portion, a second portion, a third portion, and a fourth portion, each of the first portion, the second portion, the third portion, and the forth portion fixed to the footprint; and
a second member formed of a second material different than the first material and attached to the bottom surface,
wherein when the first member is in the collapsed shape, the first portion, the second portion, the third portion, and the fourth portion of the wall are stacked on the bottom surface opposite the second member.

11. The collapsible container of claim 10, wherein the footprint of the bottom surface is a first footprint, and the second member has a second footprint larger than the first footprint; and
wherein when the first member is in the receptacle shape, the second member shields the first member from a heat source.

12. The collapsible container of claim 10, wherein the first member comprises a polygonal sheet.

13. The collapsible container of claim 10, wherein the second member comprises a polygonal plate.

14. The collapsible container of claim 10, wherein the first material comprises a composite material, and the second material comprises a material resistant to damage by fire up to about 1500 degrees centigrade.

15. The collapsible container of claim 10, further comprising a plurality of creases arranged in the first member to fold the first member between the planar shape, the parallelepiped shape, and the collapsed shape.

16. The collapsible container of claim 10, further comprising a strap having a first end opposite a second end, at least one of the first end or the second end being attachable to the wall.

17. A collapsible container for cooking sustenance comprising:
a sheet including a plurality of creases arranged in the sheet to fold the sheet between a planar shape, a receptacle shape, and a collapsed shape, the receptacle shape including:
a bottom surface having a footprint; and
a wall having a first portion, a second portion, a third portion, and a fourth portion, each of the first portion, the second portion, the third portion, and the forth portion fixed to the footprint; and
a plate attached to the bottom surface,
wherein when the sheet is in the collapsed shape, the first portion, the second portion, the third portion, and the fourth portion of the wall are stacked on the bottom surface opposite the plate.

18. The collapsible container of claim 17, wherein the plurality of creases comprises about four creases arranged in the bottom surface.

19. The collapsible container of claim 17, wherein the plurality of creases comprises about twelve creases arranged in the wall.

20. The collapsible container of claim 17, wherein, the footprint of the bottom surface is a first footprint, and the plate has a second footprint larger than the first footprint; and
wherein when the sheet is in the receptacle shape, the plate shields the sheet from a heat source while cooking sustenance.
